(19) United States
(12) Patent Application Publication
(10) Pub. No.: US 2012/0263829 A1
(43) Pub. Date: Oct. 18, 2012

(54) SYSTEM, APPARATUS AND METHOD FOR PREPARING A BEVERAGE

(75) Inventors: Ralf Kamerbeek, De Meern (NL); Angenita Dorothea Post van Loon, Utrecht (NL); Hendrik Cornelis Koeling, Amersfoort (NL)

(73) Assignee: Sara Lee/DE B. V.

(21) Appl. No.: 13/326,296

(22) Filed: Dec. 14, 2011

Related U.S. Application Data
(63) Continuation of application No. PCT/NL2009/050823, filed on Dec. 30, 2009.

(30) Foreign Application Priority Data
Jun. 17, 2009 (EP) 09162988.1

(51) Int. Cl. A47J 31/44; A23F 5/26; B65D 85/804

(52) U.S. Cl. 426/77; 99/295; 426/431

(57) ABSTRACT

A system for preparing a predetermined quantity of beverage suitable for consumption using an extractable product is disclosed. The system comprises an exchangeable capsule, and an apparatus comprising a receptacle for holding the exchangeable capsule. The exchangeable capsule is an open capsule with an exit filter adapted to drain prepared beverage from the system into a cup. The apparatus comprises exit filter piercing means that are provided in the receptacle opposite of the exit filter of the capsule. The exit filter piercing means cooperate with the exit filter to pierce the exit filter to create at least one additional opening, wherein the exit filter, when used in a prior art apparatus that has lid piercing means to pierce a lid of a closed capsule, is not pierced by the lid piercing means and stays intact.

### CROSS-REFERENCE TO RELATED APPLICATIONS

The present application is a continuation of International Patent Application Serial No. PCT/NL2009/050823 filed on Dec. 30, 2009; which claimed priority to European Application Serial No. EP 09162988.1 filed on Jun. 17, 2009, all of which are hereby incorporated herein by reference.

### FIELD OF THE INVENTION

The invention relates to a system for preparing a predetermined quantity of beverage suitable for consumption using an extractable product, comprising an exchangeable capsule, and an apparatus comprising a receptacle for holding the exchangeable capsule, and a fluid dispensing device for supplying an amount of a fluid, such as water, under pressure to the exchangeable capsule, wherein the exchangeable capsule comprises a circumferential wall, a bottom closing the circumferential wall at a first end, and a lid closing the circumferential wall at a second end opposite the bottom, wherein the wall, bottom and lid enclose an inner space comprising the extractable product, wherein the bottom comprises an entrance area and the system is arranged for bringing the fluid dispensing device in fluid connection with the entrance area for supplying the fluid to the extractable product for preparing the beverage, wherein the lid comprises an exit area and the system comprises an outlet which, in use, is in fluid communication with the exit area for draining the prepared beverage from the capsule and supplying the beverage to a container such as a cup, wherein the capsule of the system is an open capsule and wherein the exit area of capsule comprises an exit filter provided in the lid of said capsule for draining the prepared beverage there through.

### BACKGROUND

Such systems are known per se. In such a system an open capsule comprising the extractable product may be used to prepare a beverage. An open capsule comprises at least an exit area that is open to ambient atmosphere, although the open capsule may be contained in an e.g. airtight outer package. The open exit area may comprise an exit filter that is arranged to drain the prepared beverage there through. The known systems may be used for preparing the beverage using a hermetically sealed, e.g. prior art, closed capsule comprising the extractable product. A prior art apparatus of the system may therefore at least be provided with lid piercing means. During beverage preparation, the entrance area of such, e.g. prior art, closed capsule is first pierced by bottom piercing means arranged in the prior art apparatus, hence providing at least one entrance opening for supplying the fluid under pressure to the exchangeable product in the inner space of the capsule through the entrance opening. Providing the fluid under pressure to the inner space causes the pressure in the inner space of the capsule to rise. This, in turn, causes the exit area of the, e.g. prior art, closed capsule to be pressed against lid piercing means present in the support surface of the receptacle. When the exit area is pressed against the lid piercing means with sufficient force, the exit area tears against the lid piercing means creating at least one exit opening through which the beverage can drain from the capsule.

When the above mentioned open capsule is used in the prior art apparatus of the system comprising lid piercing means, the lid of the open capsule is not pierced by the lid piercing means of the prior art apparatus since the exit filter is adapted to stay intact when contacting the lid piercing means of the prior art apparatus.

When preparing a beverage with the prior art system using an open capsule having an exit filter that is not pierced, for certain types of beverages to be prepared the flow speed of the fluid through the beverage may be too low to obtain said type of beverage with a desired quality within a desired preparing time period.

### SUMMARY

It is therefore an object of the invention to provide a system according to the above described type, wherein the advantages of the known system are maintained and the disadvantages of the known system are at least partly overcome. More in particular, it is an object of the invention to provide a system for preparing a predetermined quantity of beverage wherein the fluid flow speed can be increased when using an open capsule.

Thereto, according to a first aspect of the invention, is provided a system for preparing a predetermined quantity of beverage suitable for consumption using an extractable product, comprising: an exchangeable capsule, and an apparatus of a first type comprising a receptacle for holding the exchangeable capsule, and a fluid dispensing device for supplying an amount of a fluid, such as water, under pressure to the exchangeable capsule, wherein the exchangeable capsule comprises a circumferential wall, a bottom closing the circumferential wall at a first end, and a lid closing the circumferential wall at a second end opposite the bottom, wherein the wall, bottom and lid enclose an inner space comprising the extractable product, herein the bottom comprises an entrance area and the system is arranged for bringing the fluid dispensing device in fluid connection with the entrance area for supplying the fluid to the extractable product for preparing the beverage, herein the lid comprises an exit area and the system comprises an outlet which, in use, is in fluid communication with the exit area for draining the prepared beverage from the capsule and supplying the beverage to a container such as a cup, wherein the capsule of the system is an open capsule and wherein the exit area of capsule comprises an exit filter provided in the lid of said capsule for draining the prepared beverage there through, wherein the exit filter of the open capsule, when being used in an apparatus of a second type, such as a prior art apparatus, that comprises lid piercing means intended for piercing a lid of a, e.g. prior art, closed capsule, in use is not pierced by the lid piercing means of the apparatus of the second type and the exit filter of the open capsule stays intact, wherein the receptacle of the apparatus of the system comprises exit filter piercing means intended for piercing the exit filter of the capsule for creating at least one additional opening in the exit filter, wherein the exit filter piercing means and the exit filter are adapted to each other such that the exit filter that is not pierced in the apparatus of the second type is pierced by the exit filter piercing means to provide an enlarged flow of prepared beverage from the capsule to the outlet of the system.

Thus, by providing exit filter piercing means that are adapted to the exit filter of the open capsule such that during use of the system the exit filter may be pierced by the exit filter piercing means, at least one additional, for instance larger, outflow opening next to the openings already available in the exit filter may be provided in the exit filter. Hence, due to such an additional opening the prepared beverage may be drained from the capsule under an increased speed. This may be advantageous when for instance a coffee longo is to be prepared, wherein the quantity of prepared beverage is larger than for instance when an espresso is prepared. This results in a faster outflow of the prepared beverage resulting in a desired preparation time of the beverage. Furthermore, by providing the exit filter piercing means also the strength of the beverage may be influenced. The exit filter piercing means may comprise a piercing plate arranged adjacent a support surface of the receptacle. The piercing elements preferably extend from the piercing plate towards the exit filter of the capsule.

In further elaboration of the invention, the exit filter piercing means may comprise at least one piercing element that has a sharp piercing surface. Preferably, the sharp piercing surface has a sharpness that is adapted to pierce the exit filter of the open capsule, more specifically to pierce the exit filter material of the open capsule that is not pierced with the lid piercing means of the, e.g. prior art, apparatus of the second type of the system.

According to a further aspect of the invention, the sharp piercing surface may have a radius of curvature that is smaller than 50 μm, preferably smaller than 30 μm, more preferably smaller than 20 μm. Furthermore, the at least one piercing element has a piercing angle that is ≦60°, preferably that is ≦45°, more preferably that is ≦30°, wherein the piercing angle is defined by an angle enclosed by opposing piercing element sides seen in a piercing direction. The piercing direction may be defined as a direction from the piercing plate towards the exit filter of the open capsule of the system.

According to another aspect of the invention, the exit filter piercing means may comprise a plurality of piercing elements that may be arranged in a piercing pattern. Different piercing patterns may be provided, for instance dependent on the desired fluid flow through the capsule in order to prepare a special type of coffee. For instance, the piercing pattern may comprise a plurality of piercing elements that are adapted to create little additional openings in the exit filter. The piercing patter may instead comprise a few piercing elements that are adapted to create a few larger additional openings in the exit filter. With the latter pattern a different fluid flow may be created through the extractable product provided in the open capsule than with the first mentioned piercing pattern. A lot of different patterns may be provided comprising different piercing elements and different amounts of piercing elements that are arranged in different compositions on the piercing plate.

It is possible that the exit filter piercing means are arranged for piercing the exit filter upon contact, e.g. while closing the apparatus. It is also possible that the exit filter piercing means are arranged for piercing the exit filter under the influence of the pressure of the fluid, such as water, in the capsule.

Furthermore, to control the fluid flow in a predetermined manner, the piercing elements of the piercing pattern may comprise different sharp piercing surfaces with different radii of curvature. Thus, not all piercing elements of the same piercing pattern may have a similar sharp piercing surface with a similar radius of curvature.

In order to provide a multi-functional system for preparing a beverage, the exit filter piercing means may be removably arranged in the apparatus. Consequently, dependent on the kind of beverage to be prepared, the most suitable exit filter piercing means may be chosen. Furthermore, the exit filter piercing means may also be chosen in dependence of a certain type of exit filter, for instance a certain type of material and/or comprising a certain amount of openings with certain dimensions, provided in the open capsule. For example, if the exit filter is of a more elastic material, the piercing elements may be more sharp than if the exit filter comprises a less elastic material.

Optionally, the system further comprises an apparatus of the second type that comprises lid piercing means intended for piercing a lid of a closed capsule, wherein the pierced by the lid piercing means of the apparatus of the second type are arranged for leaving the exit filter of the open capsule intact.

The invention also relates to a method for preparing a predetermined quantity of beverage suitable for consumption using an extractable product, comprising providing an exchangeable capsule, comprising a circumferential wall, a bottom closing the circumferential wall at a first end, and a lid closing the circumferential wall at a second end opposite the bottom, wherein the wall, bottom and lid enclose an inner space comprising the extractable product, wherein the capsule is an open capsule comprising an exit filter in the lid of the capsule, providing an apparatus of a first type comprising a receptacle for holding the exchangeable capsule, a fluid dispensing device for supplying an amount of a fluid, such as water, under pressure to the exchangeable capsule, and an outlet which, in use, is in fluid communication with the capsule for draining the prepared beverage from the capsule and supplying the beverage to a container such as a cup, wherein the exit filter of the open capsule, when being used in an, e.g. prior art, apparatus of a second type that comprises lid piercing means intended for piercing a lid of a, e.g. prior art, closed capsule, in use is not pierced by the lid piercing means of the, e.g. prior art, apparatus of the second type such that the exit filter of the open capsule stays intact, wherein the receptacle of the apparatus of the first type of the system comprises exit filter piercing means that pierces the exit filter of the capsule to create at least one additional opening in the exit filter, wherein the exit filter piercing means and the exit filter cooperate such that the exit filter that is not pierced in the, e.g. prior art, apparatus of the second type is pierced by the exit filter piercing means and provides an enlarged flow of prepared beverage draining from the capsule to the outlet of the system, and supplying the fluid to the extractable product for preparing the beverage. Such a method provides similar effects and advantages as mentioned with the above described system.

These and other features and advantages of the invention will be more fully understood from the following detailed description of certain embodiments of the invention, taken together with the accompanying drawings, which are meant to illustrate and not to limit the invention.

### BRIEF DESCRIPTION OF THE DRAWINGS

The invention will now be further elucidated by means of, non-limiting, examples referring to the drawing, in which:

FIG. 1 schematically shows a prior art apparatus for preparing a beverage comprising an open capsule;

FIG. 2 schematically shows a first embodiment of the system according to the invention;

FIG. 3 schematically shows the first embodiment of the system in operation; and

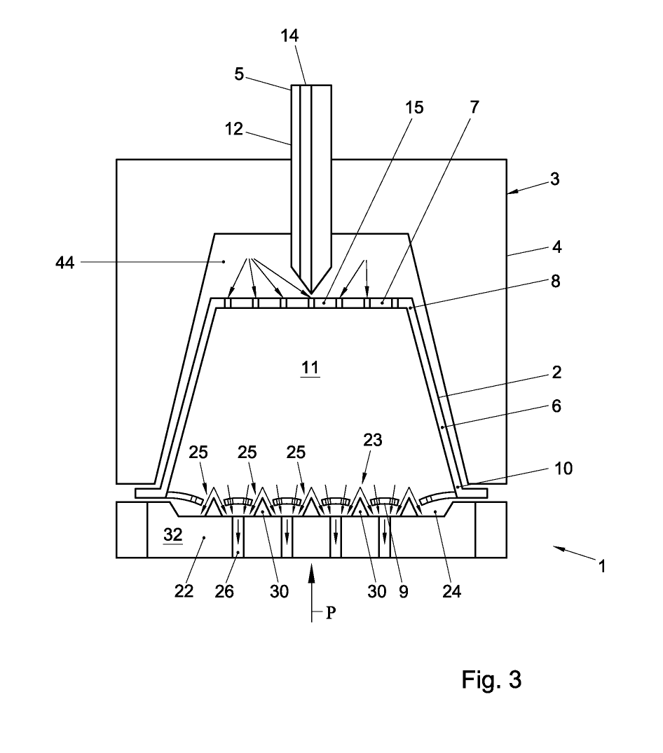

FIGS. 4-6 schematically show different embodiments of exit filter piercing means of an apparatus of the system according the invention.

It is noted that identical or corresponding elements in the different drawings are indicated with identical or corresponding reference numerals.

### DESCRIPTION OF EXEMPLARY EMBODIMENTS

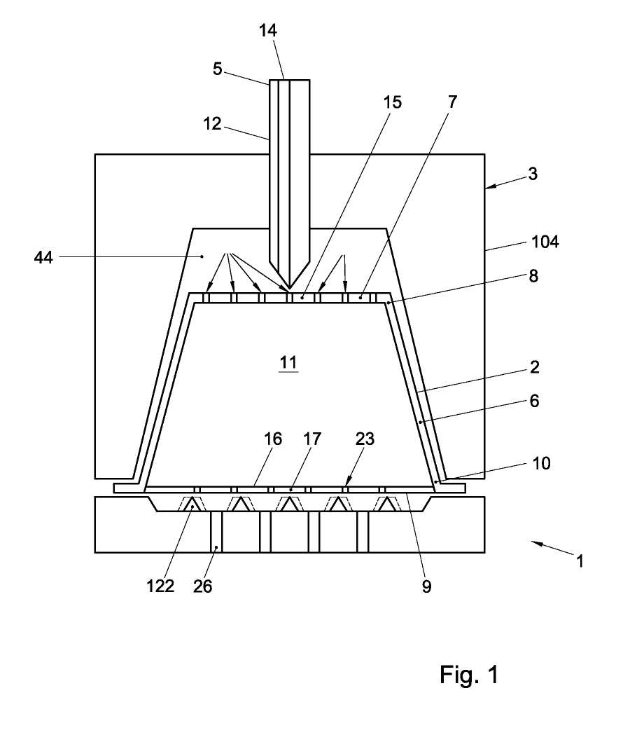

FIG. 1 shows a prior art apparatus 104 for preparing a predetermined quantity of beverage suitable for consumption using an extractable product. The apparatus 104 comprises an exchangeable open capsule 2. The apparatus 104 comprises a receptacle 3 for holding the exchangeable open capsule 2. Commonly, the receptacle 3 has a shape at least partly complementary to the shape of the capsule 2. The apparatus 104 further comprises a fluid dispensing device 5 for supplying an amount of a fluid, such as water, under a pressure, of e.g. 9 bars, to the exchangeable capsule 2.

The exchangeable open capsule 2, as provided in the receptacle 3 of the apparatus 104, comprises a substantially rigid circumferential wall 6, a bottom 7 closing the circumferential wall 6 at a first end 8, and a lid 9 closing the circumferential wall 6 at a second end 10 opposite the bottom 7. The circumferential wall 6, the bottom 7 and the lid 9 enclose an inner space 11 comprising the extractable product. The circumferential wall 6 of the capsule 2 may e.g. comprise a plastics material and may be formed by e.g. injection moulding, vacuum-forming, thermoforming or the like. Also, in the example of FIG. 1, the circumferential wall 10 is frusto-conical, but other shapes are also possible. For example, the circumferential wall may be cylindrical or pyramidal. Preferably, the extractable product comprises an amount of roasted and ground coffee.

The apparatus 104 comprises bottom piercing means 12 intended for piercing a prior art closed capsule (not shown). The bottom piercing means 12 comprise a bore 14 through which the fluid can be supplied to the extractable product contained in the inner space of the prior art closed capsule. The open capsule 2 as provided in the apparatus 104 is not pierced by the bottom piercing means 12. The fluid from the fluid dispensing device 5 enters the cavity 44 provided between the receptacle 3 and the open capsule 2 through the bore 14. The open capsule 2 comprises an entrance filter 15 provided in the bottom 7 adapted to drain fluid from the cavity 44 to the inner space 11 of the open capsule 2 for extracting desired substances from the extractable product, in this example approximately 5-6.5 grams of roasted and ground coffee, for preparing, in this example a single cup of beverage from 30-100 ml, here espresso. The bottom 7 of the open capsule 2 comprises an entrance area, formed by the entrance filter 15 which is positioned at a distance from the bottom piercing means 12. The apparatus 104 is arranged for bringing the fluid dispensing device 5 in fluid connection with the entrance area for supplying the fluid to the extractable product for preparing the beverage.

The open capsule 2 is further provided with an exit area 16 forming exit filter 17. The exit filter 17 is provided with openings 23 adapted to drain the prepared beverage from the capsule 2 to the outlet 26 of the system 104. The exit filter 17 comprises a flexible sheet-shaped perforate and/or porous material, in this embodiment a flexible foil such as a polymeric film with a plurality of openings 23 through which the beverage can drain from the capsule 2. The flexible foil may be a multilayer foil of a polyethyleneterephthalate (PET-P) layer of approximately 12 μm and a chlorinated polypropylene (CPP) layer of approximately 30 μm. The flexible foil may also be a multilayer foil of a PET-P layer of approximately 15 μm and a CPP layer of approximately 30 μm. In this example, the exit filter comprises 75-170 openings for instance 100-170 opening, preferably 90-150 openings for instance 110-150 openings, more preferably 100-125 openings. The exit filter may also comprise approximately 145 openings. The opening diameter may be between 0.4 mm±0.05 mm and 0.2 mm±0.05 mm, preferably approximately 0.3 mm±0.05 mm. These openings enable the prepared beverage to drain from the capsule 2.

The apparatus 104 further comprises lid piercing means 122, here embodied as protrusions with a relatively blunt piercing surface, intended for piercing the lid of a prior art closed capsule (not shown). The exit filter 17 of the open capsule 2 according to FIG. 1 is not pierced by the lid piercing means 26. The exit filter 17 is sufficiently strong and sufficiently stiff not to be pierced by the lid piercing means 122 of the prior art apparatus of the system 1 under the influence of the pressure inside the capsule 2. Under influence of the pressure inside the capsule 2, the exit filter 17 may deform against the lid piercing means 122, but it may not tear, rupture or be pierced by the lid piercing means such that the exit filter 17 stays intact under influence of the pressure. The system 104 as shown in FIG. 1 can be used in advantage to prepare an amount of beverage such as espresso. However, when preparing a larger amount of beverage, for instance 120-200 ml from the same open capsule, for instance a coffee longo, the fluid flow through the capsule may be to slow, resulting in a relatively long preparation time and in a cup of coffee that may be over extracted for its desired purpose.

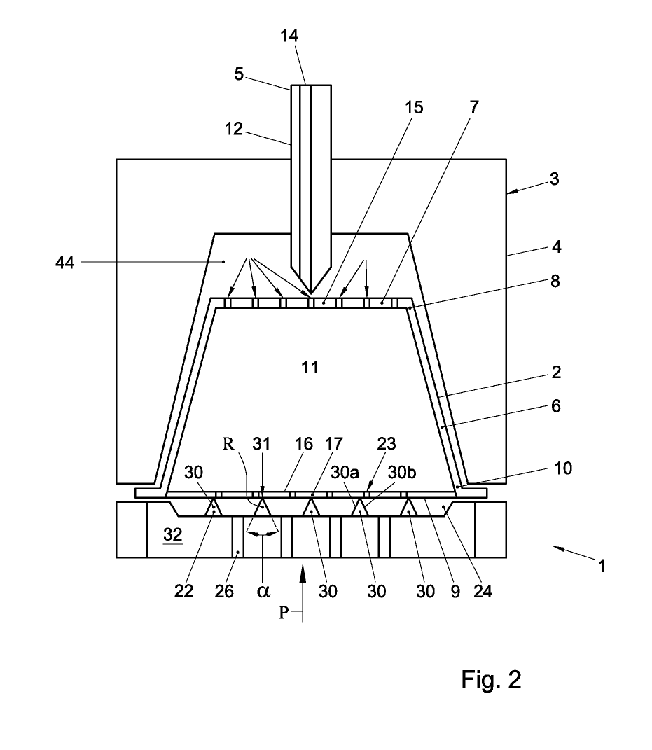

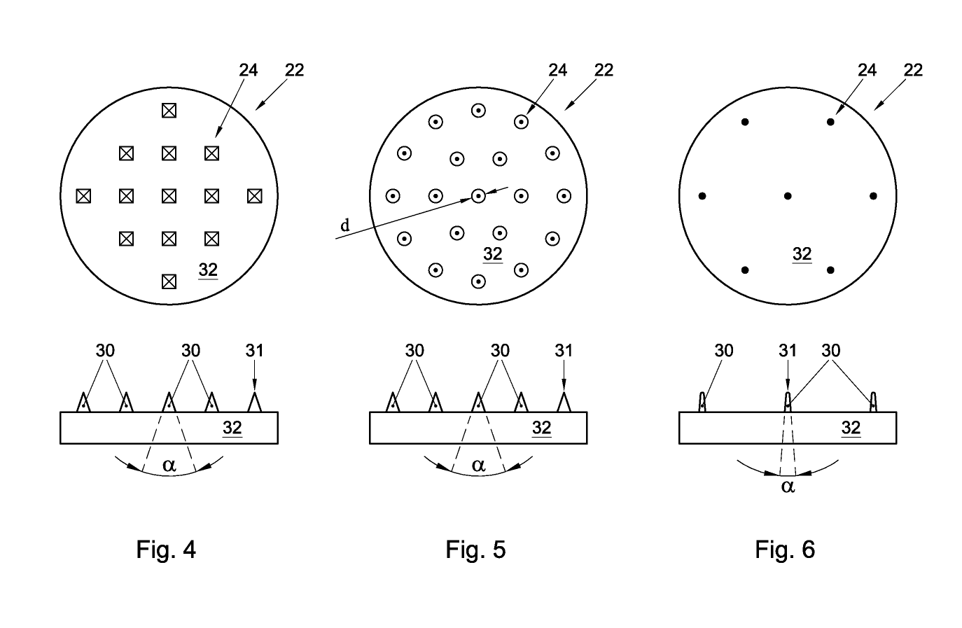

Therefore, the system 1 according to the invention as shown in FIG. 2 is provided. For the sake of clarity, only the elements that differ from the system 1 as shown and described with FIG. 1 will be described here in detail. The apparatus 4 according to the invention is provided with exit filter piercing means 22 that is adapted to cooperate with the exit filter 17 of the open capsule such that in use the exit filter 17 that is not pierced by the lid piercing means 122 of the prior art apparatus is actually pierced by the exit filter piercing means 22 according to the invention. The exit filter piercing means 22 according to this example comprises a plurality of piercing elements 30 that extend in the piercing direction P from the piercing plate 32 towards the exit filter 17 of the open capsule 2. The piercing elements 30 have a sharp piercing surface 31 with a radius of curvature R that is smaller than 50 μm, preferably smaller than 30 μm, more preferably smaller than 20 μm. Such a sharp piercing surface is able to pierce the exit filter 17 that is relatively deformable and/or elastically due to its material properties. The piercing elements 30 may have a piercing angle α that is smaller than 60°, in this example smaller than 45°. In another example of the system 1 according to the invention, the piercing angle α may even be smaller than 30°. The piercing angle α may be defined by angle enclosed by opposing piercing element sides 30a, 30b seen in a piercing direction P (see FIG. 2). In the shown example, the piercing elements are arranged in a piercing pattern 24 so as to pierce the exit filter 17 on different locations along the entire surface of the exit filter 17. The exit filter piercing means 22 may be removably arranged in the apparatus 4. The exit filter piercing means 22 may be removed and replaced with another kind of exit filter piercing means 22 for instance dependent on the kind of beverage to be prepared. Different exit filter piercing means 22 are shown in FIGS. 4-6.

The system 1 as shown in FIG. 2 is operated as follows for preparing a cup of for instance coffee longo, wherein the extractable product is roasted and ground coffee and the amount of beverage to be prepared is approximately 120-200 ml.

The open capsule 2 comprising the exit filter 17 is placed in the receptacle 3 such that the exit filter 17 faces the exit filter piercing means 22. The receptacle 3 is closed. Then the fluid, here hot water under pressure, is supplied to the extractable product in the inner space 11 through the opening 13 via the bore 14 provided in the piercing means 12. Preferably, the fluid dispensing device 5 is arranged for supplying the fluid to the open capsule 2 under a pressure of approximately 4-20 bars, preferably 9-15 bars. During preparing of the beverage, the fluid from the fluid dispensing device 5 enters the cavity 44 provided between the receptacle 3 and the open capsule 2 through the bore 14. The entrance filter 15 is adapted to drain fluid from the cavity 44 to the inner space 11 of the open capsule 2 for extracting desired substances from the extractable product. Providing the fluid under pressure to the inner space 11 causes the pressure in the capsule 2 to rise such that the exit filter 17 is pressed against the exit filter piercing means 22.

Since the exit filter 17 and the exit filter piercing means 22 are adapted to each other, the piercing elements 30 pierce the exit filter 17 when it is pressed against the sharp piercing surfaces 31 of the piercing elements 30 due to the fluid pressure. The piercing elements 30 create additional openings 25 in the exit filter next to the openings 23 of the exit filter 17. These additional openings 25 provide for an increased fluid flow through the capsule 2. Thus, the water will wet the coffee grounds and extract the desired substances to form the coffee beverage with a desired quality. The fluid will pass through the capsule 2 with an increased flow speed such that an amount of 120-200 ml coffee may be prepared within an acceptable preparation time. The prepared coffee will drain from the capsule 2 and may be supplied to a container such as a cup (not shown). Preferably, the additional openings 25 are formed such that when removing the used capsule 2 from the receptacle 3 of the apparatus 4, the roast and ground coffee stays inside the capsule.

In FIGS. 4-6, three further embodiments of the exit filter piercing means 22 according to the invention are shown. Said exit filter piercing means 22 can be used in a system 1 according to the invention. The piercing means 22 comprise a piercing plate 32 from which an amount of sharp piercing elements 30 extends in a direction away from the plate 32. The piercing elements 30 have a sharp piercing surface 31 that is sharp enough to pierce the exit filter 17 of the open capsule 2 according to the invention, which exit filter 17 is not pierced by lid piercing means 122 of a prior art apparatus 104 of the system 1. Thus, the piercing elements 30 have to overcome a piercing resistance of the exit filter 17. The piercing elements 30 can be arranged in different patterns 24 as can be seen in FIG. 4-6. Each of the exit filter piercing means 22 can be provided in the receptacle 3 of the apparatus, for instance dependent on a desired beverage to be prepared. The amount of piercing elements 30 may vary, as well as the radius of curvature R of the sharp piercing surface 31 of the respective elements 30. Furthermore, the piercing angle α may vary as well as the location of the separate piercing elements 30 on the piercing plate. The piercing elements 30 may have different cross sections in a plane extending substantially parallel to the piercing plate 32, such as a square or circular cross section. Furthermore, the cross sections of the piercing elements in a plane extending substantially perpendicular to the piercing plate 32 may also have different shapes. The piercing pattern 24 may comprise different piercing elements 30 as can be seen in FIG. 5. The centre piercing element 30 has a larger diameter d than the other piercing elements 30. In case the system 1 is used to prepare a cup of espresso from an open capsule 2, the exit filter piercing means 22 may be removed from the apparatus 4 and be replaced with a support plate without piercing elements of with protrusions that are not able to overcome the piercing resistance of the exit filter 17 of the capsule.

In the foregoing specification, the invention has been described with reference to specific examples of embodiments of the invention. It will, however, be evident that various modifications and changes may be made therein without departing from the broader spirit and scope of the invention as set forth in the appended claims. For instance, the capsule may have different dimensions and be made of different material. Furthermore, the capsule 2 may only have an exit filter 17 and no entrance filter. For supplying the fluid to the inner space of the capsule, the bottom piercing means of the system may be used. It is also possible that the apparatus of the system does not comprise bottom piercing means and has a different fluid dispensing device to supply fluid to the inner space of the capsule. Also different kinds of exit filter piercing means may be used to pierce the exit filter of the capsule, as long as the piercing resistance of the exit filter of the capsule is overcome by the piercing elements.

In the examples, the apparatus 104 is a prior art apparatus. It is also possible that the apparatus 104 is an alternative apparatus. It is possible to provide the apparatus 4 of the first type and the apparatus 104 of the second type simultaneously. It is also possible that the apparatus 104 of the first type and the apparatus 4 of the second type are integrated into one machine. It will be appreciated that also with such variants the desired advantages may be obtained.

However, other modifications, variations and alternatives are also possible. The specifications, drawings and examples are, accordingly, to be regarded in an illustrative rather than in a restrictive sense.

In the claims, any reference signs placed between parentheses shall not be construed as limiting the claim. The word ‘comprising’ does not exclude the presence of other features or steps then those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to advantage.

What is claimed is:

1. A system for preparing a predetermined quantity of beverage suitable for consumption using an extractable product, the system comprising:
an exchangeable capsule; and
a first apparatus comprising a receptacle for holding the exchangeable capsule, and a fluid dispensing device for supplying an amount of a fluid, such as water, under pressure to the exchangeable capsule;
wherein the exchangeable capsule comprises a circumferential wall, a bottom closing the circumferential wall at a first end, and a lid closing the circumferential wall at a second end opposite the bottom, wherein the wall, bottom and lid enclose an inner space comprising the extractable product;
wherein the bottom comprises an entrance area and the system is arranged for bringing the fluid dispensing device in fluid connection with the entrance area for supplying the fluid to the extractable product for preparing the beverage;
wherein the lid comprises an exit area and the system comprises an outlet which, in use, is in fluid communication with the exit area for draining the prepared beverage from the exchangeable capsule and supplying the beverage to a container such as a cup;
wherein the exchangeable capsule is an open capsule and wherein the exit area of the exchangeable capsule comprises an exit filter provided in the lid of the exchangeable capsule for draining the prepared beverage there through, wherein the exit filter of the open capsule, when being used in a second apparatus that comprises lid piercing means intended for piercing a lid of a closed capsule, in use is not pierced by the lid piercing means of the second apparatus and the exit filter of the open capsule stays intact; and
wherein the receptacle of the first apparatus comprises exit filter piercing means intended for piercing the exit filter of the capsule for creating at least one additional opening in the exit filter, wherein the exit filter piercing means and the exit filter are adapted to each other such that the exit filter that is not pierced in the second apparatus is pierced by the exit filter piercing means to provide an enlarged flow of prepared beverage from the exchangeable capsule to the outlet of the system.

2. The system of claim 1, wherein the exit filter piercing means comprises at least one piercing element that has a sharp piercing surface.

3. The system of claim 2, wherein the sharp piercing surface has a radius of curvature that is less than 50 μm.

4. The system of claim 2, wherein the at least one piercing element has a piercing angle that is less than or equal to 60 degrees, wherein the piercing angle is defined by an angle enclosed by opposing piercing element sides seen in a piercing direction.

5. The system of claim 2, wherein the exit filter piercing means comprises a plurality of piercing elements arranged in a piercing pattern.

6. The system of claim 5, wherein the piercing elements of the piercing pattern comprise different sharp piercing surfaces with different radii of curvature.

7. The system of claim 1, wherein the exit filter piercing means are removably arranged in the first apparatus.

8. The system of claim 1, wherein the exit filter is formed by a flexible sheet-shaped perforate and/or porous material, such as a filtering paper or a flexible foil such as a polymeric film, provided with a plurality of exit openings.

9. The system of claim 8, wherein the flexible foil is a multilayer foil of polyethyleneterephthalate and chlorinated polypropylene.

10. The system of claim 9, wherein the foil comprises a first layer of polyethyleneterephthalate with a thickness of approximately 15 μm and a second layer of chlorinated polypropylene of approximately 30 μm.

11. The system of claim 1, wherein the exit filter comprises 75-170 openings, wherein an opening diameter is approximately 0.35 mm to approximately 0.45 mm.

12. The system of claim 1, wherein the lid piercing means of the second apparatus is configured for leaving the exit filter of the open capsule intact.

13. An apparatus for use in a system for preparing a predetermined quantity of beverage suitable for consumption from an exchangeable open capsule having a circumferential wall, a bottom closing the circumferential wall at a first end, and a lid closing the circumferential wall at a second end opposite the bottom, the wall, the bottom and the lid enclose an inner space comprising an extractable product, the system comprising:
a receptacle for holding the exchangeable open capsule;
a fluid dispensing device for supplying an amount of a fluid under pressure to the exchangeable open capsule;
exit filter piercing means for piercing the exit filter of the exchangeable open capsule for creating at least one additional opening in the exit filter;
wherein the exit filter piercing means is configured to pierce the exchangeable open capsule but not pierce an exchangeable closed capsule.

14. A capsule for use in a system for preparing a predetermined quantity of beverage suitable for consumption and having an apparatus comprising a receptacle and a fluid dispensing device for supplying an amount of a fluid, the capsule comprising:
a circumferential wall;
a bottom closing the circumferential wall at a first end;
a lid closing the circumferential wall at a second end opposite the bottom;
wherein the wall, the bottom and the lid enclose an inner space comprising the extractable product;
wherein the bottom comprises an entrance area and the system is arranged for bringing the fluid dispensing device in fluid connection with the entrance area for supplying the fluid to the extractable product for preparing the beverage;
wherein the lid comprises an exit area and the system comprises an outlet which, in use, is in fluid communication with the exit area for draining the prepared beverage from the exchangeable capsule and supplying the beverage to a container such as a cup; and
wherein the exchangeable capsule is an open capsule and wherein the exit area of the exchangeable capsule comprises an exit filter provided in the lid of the exchangeable capsule for draining the prepared beverage there through, wherein the exit filter of the open capsule, when being used in a second apparatus that comprises lid piercing means intended for piercing a lid of a closed capsule, in use is not pierced by the lid piercing means of the second apparatus and the exit filter of the open capsule stays intact.

15. A method of preparing a predetermined quantity of beverage suitable for consumption using an extractable product, comprising:
providing an exchangeable capsule, comprising a circumferential wall, a bottom closing the circumferential wall at a first end, and a lid closing the circumferential wall at a second end opposite the bottom, wherein the wall, bottom and lid enclose an inner space comprising the extractable product, wherein the capsule is an open capsule comprising an exit filter in the lid of the capsule,
providing an apparatus of a first type comprising a receptacle for holding the exchangeable capsule, a fluid dispensing device for supplying an amount of a fluid, such as water, under pressure to the exchangeable capsule, and an outlet which, in use, is in fluid communication with the capsule for draining the prepared beverage from the capsule and supplying the beverage to a container such as a cup,
wherein the exit filter of the open capsule, when being used in an apparatus of a second type that comprises lid piercing means intended for piercing a lid of a closed capsule, in use is not pierced by the lid piercing means of the apparatus of the second type such that the exit filter of the open capsule stays intact
wherein the receptacle of the apparatus of the first type of the system comprises exit filter piercing means that pierces the exit filter of the capsule to create at least one additional opening in the exit filter, wherein the exit filter piercing means and the exit filter cooperate such that the exit filter that is not pierced in the apparatus of the second type is pierced by the exit filter piercing means and provides an enlarged flow of prepared beverage draining from the capsule to the outlet of the system, and
supplying the fluid to the extractable product for preparing the beverage.

16. The system of claim 2, wherein the sharp piercing surface has a radius of curvature that is less than 30 μm.

17. The system of claim 2, wherein the sharp piercing surface has a radius of curvature that less than 20 μm.

18. The system of claim 2, wherein the at least one piercing element has a piercing angle that is less than or equal to 45 degrees, wherein the piercing angle is defined by an angle enclosed by opposing piercing element sides seen in a piercing direction.

19. The system of claim 2, wherein the at least one piercing element has a piercing angle that is less than or equal to 30 degrees, wherein the piercing angle is defined by an angle enclosed by opposing piercing element sides seen in a piercing direction.

20. The system of claim 1, wherein the exit filter comprises 75-170 openings, wherein an opening diameter is approximately 0.15 mm to approximately 0.25 mm.

21. The system of claim 1, wherein the exit filter comprises 75-170 openings, wherein an opening diameter is approximately 0.25 mm to approximately 0.35 mm.
